(19) United States
(12) Patent Application Publication
(10) Pub. No.: US 2005/0030988 A1
(43) Pub. Date: Feb. 10, 2005

(54) Vortex laser chiller and thermal control system

(76) Inventor: John F. Nolan, Bradford, MA (US)

Correspondence Address: Agfa Corporation;Law & Patent Department, 200 Ballardvale Street, Wilmington, MA, 01887-1069, US

(21) Appl. No.: 10/637,095

(22) Filed: Aug. 8, 2003

(51) Int. Cl. H01S 3/04

(52) U.S. Cl. 372/35; 372/34

(57) ABSTRACT

A coolant loop for an imaging engine light source avoids the necessity for a chiller or an expensive thermo-electric cooler. Instead, it uses a standard heat exchanger and a pneumatically-operated cooler, such as a vortex cooler. The advantage of a pneumatically-operated cooler is that in platesetters and imagesetters, for example, compressors are typically already included in the machines as a power sources for mechanical actuation within the machines. By simply increasing the nominal capacity of these compressors, the requirement for the expensive chillers or thermo-electric coolers can be thus avoided.

### BACKGROUND OF THE INVENTION

Imagesetters and platesetters are used to expose media, which are used in many conventional offset printing systems. Imagesetters are typically used to expose the film that is then used to make the plates for the printing system. Platesetters are used to directly expose the plates.

For example, plates are typically large substrates that have been coated with photosensitive or thermally-sensitive material layers, referred to the emulsion. For large run applications, the substrates are fabricated from aluminum, although organic substrates, such as polyester or paper, are also available for smaller runs.

Computer-to-plate/film printing systems are used to render digitally stored print content onto these printing media. Typically, a computer system is used to drive an imaging engine of the platesetter or imagesetter.

The imaging engine selectively exposes the emulsion that is coated on the substrates. After this exposure, the emulsion is developed so that, during the printing process, inks will selectively adhere to the surface to transfer the ink to the print medium in the case of plate substrates.

The imaging engines of these platesetters and/or imagesetters typically have lasers that generate powerful spatially and/or temporally modulated optical signals. These optical signals are used to expose the plate or film media held on the inside or outside of the drum. Typically, the media is held on a drum that is rotated underneath the imaging engine while the imaging engine is scanned axially along the drum to expose the media on the drum. In other configurations, the media is held on a flat bed, with the media being advanced while the laser is scanned across the media.

Throughput is a critical metric for these commercial production machines. One factor limiting the speed at which they run is the power of the optical signal output from the laser light sources. The more powerful the optical signal, the faster the media can be exposed.

Because they are run at such high powers, thermal control is a critical issue in the design of the imaging engines. It is common to provide liquid cooling. Specifically, the lasers and modulators, in the imaging engines, are provided with coolant jackets or cold plates, for example, and then a coolant is flowed through these structures in order to remove the heat to prevent excessive heat build up in these devices. The heat is then removed from the coolant in a subsequent chiller. The coolant is often water.

### SUMMARY OF THE INVENTION

Problems arise, however, with these conventional coolant loops that are associated with the chillers. First, the chillers are expensive, which impacts the cost-competitiveness of the machine. Second, the chillers consume a large amount power. Moreover, they use refrigerants that periodically must be replenished and can represent a health hazard to the machine operators and maintenance personnel.

To avoid the use of chillers, some have proposed the use of thermo-electric coolers. These are devices that electronically remove heat. The problem is, however, that thermo-electric coolers also consume large amounts of power. Moreover, thermo-electric coolers that are large enough to accommodate the cooling requirements of these high power laser sources are not always commercially available.

The present invention is directed to a coolant loop for an imaging engine light source. It avoids the necessity for a chiller or an expensive thermo-electric cooler. Instead, in the preferred embodiment, it uses a standard heat exchanger and a pneumatically-operated cooler. The advantage of a pneumatically-operated cooler is that in platesetters and imagesetters, for example, compressors are typically already included in the machines as a power sources for mechanical actuation within the machines. By simply increasing the nominal capacity of these compressors, the requirement for the expensive chillers or thermo-electric coolers can be thus avoided.

In general, according to one aspect, the invention features a cooling system for an imaging engine. The imaging engine comprises a light source for exposing media. The cooling system comprises a coolant loop for cooling the light source with a coolant. A pneumatically-operated cooler is then provided for removing heat from the coolant.

In the preferred embodiment, the coolant is water. Further, a heat exchanger is preferably provided, which is downstream of the light source, but upstream of the pneumatically-operated cooler. This heat exchanger is an inexpensive way of removing large amounts of heat from the coolant, so that its temperature can be brought near to ambient temperature. A fan is preferably provided for flowing air over the heat exchanger. The speed of this fan can be controlled by a controller to thereby control the temperature of the coolant downstream of the heat exchanger. The controller preferably also controls the pneumatically-operated cooler. It allows the coolant exiting from the pneumatically-operated cooler to be at a stable, acceptable temperature for the light source.

In the preferred embodiment, the pneumatically-operated cooler is a vortex cooler. This vortex cooler preferably receives pressurized air from a compressor of a platesetter or imagesetter, in which the imaging engine is installed.

In general, according to another aspect, the invention features a method for cooling an imaging engine light source. This method comprises cooling the light source with a coolant, and then removing heat from the coolant with a pneumatically-operated cooler.

Finally, according to still another aspect, the invention features a cooling system for an imaging engine. The imaging engine comprises a light source for exposing media. A coolant loop is provided for cooling the light source with a coolant. A vortex cooler is then provided for removing heat from the coolant.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

The Figure is a schematic block diagram of a cooling system, according to the invention, for an imaging engine of a platesetter or imagesetter, for example.

### DETAILED DESCRIPTION OF THE PREFERRED EMBODIMENTS

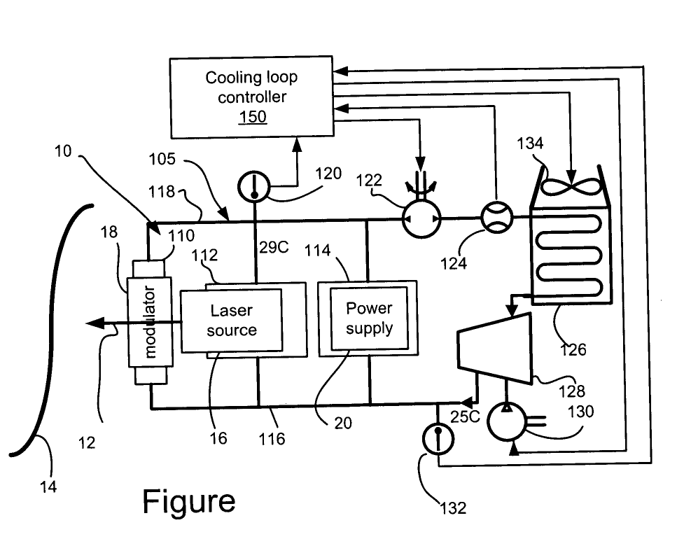

FIG. 1 shows a cooling system for an imaging engine, which has been constructed according to the principles of the present invention.

In more detail, an imaging engine 10 is provided, which generates a temporally and/or spatially modulated optical signal 12. This optical signal 12 is used to selectively expose the surface or emulsion of media 14. In the present embodiment, the media 14 is a plate or film as used in an offset printing system. The imaging engine 10 is installed in a platesetter or imagesetter in the current implementation.

In one example, the imaging engine generates the optical signal 12 using a combination of a source, and specifically a laser source 16, and a spatial light modulator 18. Preferably, the laser source 16 is a solid state laser, such a diode laser or a diode laser array, in one example.

As is common with the solid-state lasers or diode laser systems, the temperature of these light sources 16 must be controlled. Small changes in the temperature yield changes in the power of the optical signal 12 and also its wavelength. Such changes in power from the specified or nominal power level result in detrimental changes in the exposure level of the media 14. Changes in the wavelength of the optical signal 12 also yield detrimental changes. Typically, changes in wavelength erode the resolution of the system because the optics that are used to convey the optical signal 12 to the media are typically specified for very precise wavelength ranges.

In the present embodiment, a diode laser array is used that generates a rectangular beam, which is spatially modulated by a gradient light valve (GLV) modulator 18. This GLV modulator 18 spatially modulates the light in order to selectively expose the media 14 according to received image data.

A power supply 20 is also provided to power the laser source 16. In one configuration, a separate power supply provides power to the GLV.

Each of the modulator 18, laser source 16, and power supply 20 are provided with respective cold plates or water jackets 110, 112, 114, respectively. These separate coolant devices or jackets are used to remove heat that is generated in the modulator 18, laser source 16, and power supply 20 to ensure that the devices can be run at high power while preventing any excessive heat build up that could lead to improper operation or catastrophic failure produced by thermal run away.

Coolant of a cooling loop 105 of the inventive cooling system is provided to each of the cooling jackets 112, 110, 114 via an input manifold 116. Coolant is carried away from the cooling jackets 110, 112, 114 via an output manifold 118.

A hot-side temperature detector 120 is used to detect the temperature of the coolant from the laser source 116 or in the output manifold 118 generally. Temperature information is provided to a cooling loop controller 150. Thus, hot-side temperature detector 120 supplies the cooling loop controller with information concerning how much heat must be removed from the coolant in the coolant loop 105 to maintain the cold-side temperature of the coolant to the laser source 16 at the nominal or specified temperature required by the laser source 16.

A loop pump 122 is used to move the water coolant through the loop 105. In the preferred embodiment, the speed of operation of the loop pump 122 is also controlled and specified by the cooling loop controller 150.

In the preferred embodiment, a flow sensor 124 is further provided in the coolant loop to detect the flow rate of the coolant, in the coolant loop 105, to thereby enable the cooling loop controller 150 to provide for feedback control to achieve a stable coolant flow through the loop 105.

In order to remove heat from the coolant, in the coolant loop 105, and generally reduce the temperature of the loop coolant to near ambient, a heat exchanger 126 is located downstream of the laser source 112 and pump 122. This heat exchanger 126 is a radiator-type heat exchanger in one embodiment.

A heat exchanger fan 134 is provided typically with a surrounding cowling in order to flow air over the fins of the heat exchanger 126, in order to remove heat from the loop coolant, so that the loop coolant temperature is near ambient temperature after exiting the heat exchanger 126.

Downstream of the heat exchanger 126 is a pneumatically-operated cooler 126 is provided, according to the present invention. This pneumatically operated cooler 128 is preferably a vortex cooler.

A vortex cooler or tube creates cold air and hot air by forcing compressed air through a generation chamber which spins the air centrifugally along the inner walls of the tube at a high rate of speed (1,000,000 RPM) toward the control valve. A percentage of the hot, high-speed air is permitted to exit at the control valve. The remainder of the (now slower) air stream is forced to counterflow up through the center of the high-speed air stream, giving up heat, through the center of the generation chamber finally exiting through the opposite end as extremely cold air. A control valve located in the hot exhaust end can be used to adjust the temperature drop and rise for the entire vortex cooler. The generated cool air is used to further remove heat from the coolant enabling the temperature of the coolant to be lowered below ambient if necessary.

The pneumatically-operated cooler or vortex cooler 128 preferably receives compressed air from a compressor 130 that is used to actuate other systems in the imaging engine and/or larger platesetter or imagesetter system. In this way, the platesetter/imagesetter compressor 130 is used to further provide temperature control to the light source 116. This avoids the need for a separate chiller or other system for enabling the temperature control in the coolant loop for the light source 16.

In the preferred embodiment, a cold-side temperature detector 132 is provided between the light source 16 and the vortex cooler 128. This cold-side temperature detector 132 provides coolant temperature information to the cooling loop controller 150. The cooling loop controller then uses this information as a feedback loop to control the operation of the vortex cooler 128 to ensure that the temperature of the coolant that is supplied to the laser source 16 is at the nominal operating temperature. For example, in one implementation, the laser light source 16 requires coolant at 25° C., in order to operate at its nominal power and wavelength settings. In the hot side manifold, the coolant temperature is typically about 29° C.

While this invention has been particularly shown and described with references to preferred embodiments thereof, it will be understood by those skilled in the art that various changes in form and details may be made therein without departing from the scope of the invention encompassed by the appended claims.

1. A cooling system for an imaging engine, the imaging engine comprising a light source for exposing media, the system comprising:
a coolant loop for cooling the light source with a coolant; and
a pneumatically-operated cooler for removing heat from the coolant.

2. A cooling system as claimed in claim 1, wherein the coolant is water.

3. A cooling system as claimed in claim 1, further comprising a heat exchanger for removing heat from the coolant.

4. A cooling system as claimed in claim 3, wherein the heat exchanger is located in the coolant loop downstream of the light source and upstream of the pneumatically-operated cooler.

5. A cooling system as claimed in claim 3, further comprising a fan for flowing air over the heat exchanger.

6. A cooling system as claimed in claim 5, further comprising a cooling loop controller for controlling a speed of the fan and the pneumatically-operated cooler to thereby control a temperature of coolant to the light source.

7. A cooling system as claimed in claim 1, further comprising a cooling loop controller for controlling the pneumatically-operated cooler to thereby control a temperature of coolant to the light source.

8. A cooling system as claimed in claim 1, further comprising a cold-side temperature detector for sensing a temperature of the coolant to the light source and providing the temperature information to a cooling loop controller, which controls the operation of the pneumatically-operated cooler.

9. A cooling system as claimed in claim 1, wherein the pneumatically-operated cooler is a vortex cooler.

10. A cooling system as claimed in claim 9, wherein the vortex cooler receives pressurize air from a compressor of a platesetter or imagesetter in which the imaging engine is installed.

11. A method for cooling an imaging engine light source, the method comprising:
cooling the light source with a coolant; and
removing heat from the coolant with a pneumatically-operated cooler.

12. A method as claimed in claim 11, wherein the coolant is water.

13. A method as claimed in claim 11, further comprising removing heat from the coolant with a heat exchanger.

14. A method as claimed in claim 13, further comprising locating the heat exchanger a coolant loop downstream of the light source and upstream of the pneumatically-operated cooler.

15. A method as claimed in claim 13, further comprising flowing air over the heat exchanger.

16. A method as claimed in claim 15, further comprising controlling a speed for fan flowing the air over the heat exchanger and the pneumatically-operated cooler to thereby control a temperature of coolant to the light source.

17. A method as claimed in claim 11, further comprising controlling the pneumatically-operated cooler to thereby control a temperature of coolant to the light source.

18. A method as claimed in claim 11, further comprising detecting a cold-side temperature of the coolant and using the detected temperature in the control of the pneumatically-operated cooler.

19. A method as claimed in claim 11, wherein the pneumatically-operated cooler is a vortex cooler.

20. A method as claimed in claim 19, further comprising providing the vortex cooler with pressurize air from a compressor of a platesetter or imagesetter in which the imaging engine is installed.

21. A cooling system for an imaging engine, the imaging engine comprising a light source for exposing a media, the system comprising:
a coolant loop for cooling the light source with a coolant; and
a vortex cooler for removing heat from the coolant.
